(19) United States
(12) Patent Application Publication
(10) Pub. No.: US 2019/0316216 A1
(43) Pub. Date: Oct. 17, 2019

(54) SUGAR SOLUTION AND LIQUID SWEETENER AND BEE FEED USING SAME

(71) Applicant: B FOOD SCIENCE CO., LTD., Chita-shi, Aichi (JP)

(72) Inventors: Takumi TOCHIO, Chita-shi, Aichi (JP); Yuan LIU, Chita-shi, Aichi (JP); Yuki KIMURA, Chita-shi, Aichi (JP); Masaki KAWAI, Gifu-shi, Gifu (JP)

(21) Appl. No.: 16/470,974

(22) PCT Filed: Dec. 20, 2017
(86) PCT No.: PCT/JP2017/045840

§ 371 Date: Jun. 19, 2019

(30) Foreign Application Priority Data
Dec. 20, 2016 (JP) 2016-246669
Apr. 14, 2017 (JP) 2017-080746

(51) Int. Cl. C13B 50/00; A23K 20/163; A23K 50/90; A23L 2/60; A23L 27/30

(52) U.S. Cl. CPC C13B 50/00; A23K 20/163; A23V 2002/00; A23L 2/60; A23L 27/33; A23K 50/90

(57) ABSTRACT

[Problem]

To provide a sugar solution, in which crystal precipitation is suppressed in a low-temperature environment and which can maintain an appropriate viscosity, and a liquid sweetener and a bee feed using the sugar solution.

Solution

A sugar solution which contains sucrose, 1-kestose and glucose, wherein the content of nystose is 0-6 mass % relative to the total amount of sugars, and the content of 1-kestose is 3 parts by weight or more relative to 97 parts by weight of sucrose. According to the present invention, a sugar solution, in which crystal precipitation is suppressed in a low-temperature environment and which can maintain an appropriate viscosity, can be obtained. The sugar solution according to the present invention, which maintains excellent qualities and handling properties even in a low-temperature environment, is usable as a liquid sweetener capable of imparting an excellent flavor to foods and beverages, or a bee feed having excellent handling properties, a long shelf life and a good bee's preference.

### TECHNICAL FIELD

The present invention relates to a sugar solution. Particularly, the present invention relates to a sugar solution, in which crystal precipitation is suppressed in a low-temperature environment and which can maintain an appropriate viscosity, and a liquid sweetener and a bee feed using the sugar solution.

### BACKGROUND ART

Thick sugar solutions are also called syrups, and examples of the typical purpose thereof can include liquid sweeteners. Sugar solutions such as honey, maple syrup, and gomme syrup are widely used as liquid sweeteners for various foods and beverages including foods such as confectionery, bread, pancake, and yogurt, and beverages such as black tea and coffee. However, a problem of these sugar solutions is reduction in qualities caused by the precipitation as crystals of sugars contained therein when the sugar solutions are exposed to a low-temperature environment such as a storage or distribution environment in the winter season, or a refrigerated or chilled food department. Even if crystals are not precipitated, another problem is a markedly elevated viscosity which in turn reduces handling properties in such a way that the sugar solutions are difficult to take out of containers or are difficult to mix with foods and beverages supplemented therewith.

The sugar solutions have heretofore been used as feeds for bees such as honeybees or bumblebees. The bees play a key role in the pollination of crops such as vegetables or fruits. In addition, honeybees produce honey, beeswax, propolis, or royal jelly, which is useful in human life. For these reasons, the bees are bred by humans and used in the mediation of crop pollination or the production of honey and the like. The bees during breeding do not require feeding in the field at the time of bloom because the bees collect nectars or pollens from outside flowers and feed thereon. On the other hand, the bees require feeding for preventing debility or starvation when the amount of nectars or pollens is insufficient in the fall-winter season, a closed space (plastic greenhouse, glass room, etc.) for greenhouse horticulture, and the like. Accordingly, sugar solutions composed mainly of sucrose have heretofore been used as convenient feeds for bees. These sugar solutions for feeds require a concentration close to saturation for suppressing the proliferation of bacteria, molds or yeasts. However, a problem of saturated aqueous solutions of sucrose is difficult handling because crystals are easily precipitated when the aqueous solutions are exposed to a low-temperature environment such as the outside air temperature of the winter season.

As for these problems of crystal precipitation, for example, Example 1 of Patent Literature 1 discloses a method for producing a syrup containing glucose and sucrose at a predetermined ratio, wherein the syrup precipitates no crystal even when stored at 10° C.

### CITATION LIST

### Patent Literature

Patent Literature 1: Japanese Patent Publication No. 2009-131221

### SUMMARY OF INVENTION

### Technical Problem

Although the syrup produced by the method described in Patent Literature 1 was confirmed to precipitate no crystal at 10° C., its viscosity was not confirmed. Thus, it is uncertain whether or not the syrup can maintain an appropriate viscosity in a low-temperature environment. Specifically, in light of the conventional techniques described above, a sugar solution, in which crystal precipitation is suppressed in a low-temperature environment and which can maintain an appropriate viscosity, has not yet been fully provided. Thus, there has been a demand for the development of such a sugar solution. Furthermore, a bee feed having excellent handling properties as well as a sufficient shelf life and a high preference has not yet been fully provided. The present invention has been made to solve these problems. An object of the present invention is to provide a sugar solution and a liquid sweetener, in which crystal precipitation is suppressed in a low-temperature environment and which can maintain an appropriate viscosity, and a bee feed having excellent handling properties as well as a sufficient shelf life and a high preference.

### Solution to Problem

The present inventors have conducted diligent studies and consequently found that a sugar solution which contains sucrose, 1-kestose and glucose but contains none of fructose, nystose and maltose or has small contents thereof, and contains sucrose and 1-kestose at a predetermined ratio can markedly suppress sugar crystal precipitation in a low-temperature environment, and can maintain an appropriate viscosity even in a low-temperature environment. The present inventors have also found that the sugar solution has excellent qualities and handling properties in a low-temperature environment and is also usable as a liquid sweetener capable of imparting an excellent flavor to foods and beverages. The present inventors have further found that the sugar solution or a sugar solution containing 1-kestose and an oligosaccharide other than 1-kestose and/or a monosaccharide has excellent qualities and handling properties in a low-temperature environment and is also usable as a bee feed having a long shelf life and a high bee's preference. Accordingly, each aspect of the invention described below has been completed on the basis of these findings.

(1) The first aspect of the sugar solution according to the present invention is a sugar solution containing sucrose, 1-kestose and glucose, wherein the content of nystose is 0 to 6 mass % relative to the total amount of sugars, and 3 parts by weight or more of 1-kestose is contained per 97 parts by weight of sucrose.
(2) The second aspect of the sugar solution according to the present invention is a sugar solution having the following content of each sugar relative to the total amount of sugars: 30 to 70 mass % of sucrose, 10 to 40 mass % of 1-kestose, 5 to 30 mass % of glucose, 0 to 10 mass % of fructose, 0 to 6 mass % of nystose, and 0 to 0.1 mass % of maltose.
(3) In the sugar solution according to the present invention, a Brix sugar level as measured by a sugar refractometer can be 70 degrees or more.
(4) The sugar solution according to the present invention can have physical properties of precipitating no sugar crystal even under refrigeration at 4° C. for 21 days when the Brix sugar level as measured by a sugar refractometer is 75 degrees.
(5) The sugar solution according to the present invention can have physical properties of having a viscosity at 5° C. of 15000 mPa·s or less as measured at 200 rpm by a rotational viscometer when the Brix sugar level as measured by a sugar refractometer is 75 degrees.
(6) The liquid sweetener according to the present invention is prepared using a sugar solution according to any of (1) to (5).
(7) The bee feed according to the present invention is prepared using a sugar solution according to any of (1) to (5).
(8) The method for producing a sweetened food or beverage according to the present invention comprises the step of adding a liquid sweetener according to [6] to a food or a beverage.
(9) In the method for producing a sweetened food or beverage according to the present invention, the food or the beverage to which the liquid sweetener is to be added may be a food or a beverage to be preserved at 0° C. or higher and 10° C. or lower.
(10) The first aspect of the method for breeding a bee according to the present invention comprises the step of providing a bee feed according to (7) to the bee.
(11) The second aspect of the method for breeding a bee according to the present invention comprises the step of providing a sugar solution containing 1-kestose and an oligosaccharide other than 1-kestose and/or a monosaccharide as a feed to the bee.
(12) In the second aspect of the method for breeding a bee according to the present invention, preferably, the sugar solution contains sucrose as the oligosaccharide other than 1-kestose, wherein 3 parts by weight or more of 1-kestose is contained per 97 parts by weight of sucrose.

### Advantageous Effects of Invention

According to the present invention, a sugar solution, in which crystal precipitation is suppressed in a low-temperature environment and which can maintain an appropriate viscosity, can be obtained.

The sugar solution according to the present invention is less likely to precipitate crystals even when added to foods and beverages to be refrigerated, can be easily mixed therewith, and further imparts an excellent flavor to the foods and the beverages. Thus, the sugar solution according to the present invention can be used as a liquid sweetener. For use as a liquid sweetener, the sugar solution according to the present invention can maintain excellent qualities and handling properties even in a low-temperature environment and can therefore be displayed in a refrigerated or chilled food department, together with foods and beverages to be refrigerated which is a suitable subject to which the liquid sweetener is to be added.

The sugar solution according to the present invention neither precipitates crystals nor increases its viscosity extremely even when exposed to a low-temperature environment such as open air in the winter season, and is therefore easily handled, further resists the proliferation of contaminating microorganisms such as yeasts, and has a high bee's preference. Thus, the sugar solution according to the present invention can be used as a bee feed having excellent handling properties, a long shelf life and a good bee's preference.

### BRIEF DESCRIPTION OF DRAWINGS

FIG. 1 is a photograph showing the presence or absence of crystal precipitation when a sugar solution of Example 1 (sugar solution 1) according to the present invention and sugar solutions 2 to 5 of Comparative Examples were preserved at 4° C.

FIG. 2 is a photograph showing the presence or absence of crystal precipitation when agar-based confectionery containing 70% granulated sugar (sample 1) and agar-based confectionery containing 1-kestose substituted for 0.1 to 15% of granulated sugar (samples 2 to 9) were preserved at 4° C.

FIG. 3 is a bar graph showing viscosities at 20° C. (normal temperature) and 5° C. (low temperature) as to sugar solutions 1 to 5.

FIG. 4 is a graph showing the cell count of a yeast cultured for 2 days in a medium coated with sterilized water, any of commercially available honeybee feeds A to C, or a sugar solution of Example 6 according to the present invention (feed D).

FIG. 5 is a graph showing the cell count of a yeast cultured for 2 days in a medium coated with sterilized water or any of feeds A to D equalized in terms of a sugar level.

FIG. 6 is a photograph showing the number of attracted honeybees as to feed D and a sugar solution containing only 1-kestose (feed E).

FIG. 7 is a bar graph showing the average number of attracted honeybees as to feeds A to D and commercially available honeybee feed F.

FIG. 8 is a photograph showing the number of attracted honeybees 30 minutes after the start of a test as to feeds A to D and F.

FIG. 9 is a photograph showing the presence or absence of crystal precipitation when feeds D and F were refrigerated at 4° C. for 36 days.

### DESCRIPTION OF EMBODIMENTS

Hereinafter, the sugar solution according to the present invention and a liquid sweetener and a bee feed using the sugar solution will be described in detail. In the description below, % means mass % ((w/w) %) unless otherwise specified.

The sugar solution according to the present invention is a sugar solution containing 1-kestose and includes the “first aspect”, the “second aspect” and the “third aspect”. Among them, the sugar solutions according to the first and second aspects contain sucrose, 1-kestose and glucose but contain none of fructose, nystose and maltose or have small contents thereof, and contain sucrose and 1-kestose at a predetermined ratio. On the other hand, the sugar solution according to the third aspect contains 1-kestose and an oligosaccharide other than 1-kestose and/or a monosaccharide.

Specifically, the first aspect of the sugar solution according to the present invention is a sugar solution containing sucrose, 1-kestose and glucose, wherein the content of nystose is 0% or more and 6% or less relative to the total amount of sugars, and 3 parts by weight or more of 1-kestose is contained per 97 parts by weight of sucrose.

The second aspect of the sugar solution according to the present invention is a sugar solution which has the following content of each sugar relative to the total amount of sugars:

30% or more and 70% or less of sucrose,

10% or more and 40% or less of 1-kestose,

5% or more and 30% or less of glucose,

0% or more and 10% or less of fructose,

0% or more and 6% or less of nystose, and

0% or more and 0.1% or less of maltose.

The third aspect of the sugar solution according to the present invention is a sugar solution which contains 1-kestose and an oligosaccharide other than 1-kestose and/or a monosaccharide.

In this context, the “monosaccharide” refers to a sugar that undergoes no further hydrolysis. Examples thereof can include glucose, fructose, galactose, and mannose. The “oligosaccharide” refers to a sugar composed of 2 to 10 or several tens of monosaccharides bonded. Examples thereof can include: disaccharides such as maltose, sucrose, and lactose; trisaccharides such as 1-kestose, maltotriose, raffinose, melezitose, maltotriulose, and nigerotriose; and tetrasaccharides such as nystose, stachyose, and nigerotetraose.

In the sugar solution of the third aspect, the “oligosaccharide other than 1-kestose and/or monosaccharide” can employ any of the aforementioned oligosaccharides and monosaccharides and preferably comprises sucrose. When the sugar solution of the third aspect contains sucrose, 3 parts by weight or more of 1-kestose is preferably contained per 97 parts by weight of sucrose, from the viewpoint of enhancing a sugar crystal precipitation suppressive effect, as shown in Example 3 mentioned later.

In the sugar solution of the present invention, examples of the lower limit of the content of sucrose relative to the total amount of sugars can include 10% or more, preferably 15% or more, 20% or more, or 25% or more, more preferably 30% or more, 35% or more or 40% or more. Examples of the upper limit of the content of the sucrose relative to the total amount of sugars can include 90% or less, preferably 85% or less, 80% or less, or 75% or less, more preferably 70% or less.

In the sugar solution of the present invention, examples of the lower limit of the content of 1-kestose relative to the total amount of sugars can include 0.01% or more, 0.1% or more, 1% or more, or 5% or more, preferably 6% or more, 7% or more, or 8% or more, more preferably 9% or more or 10% or more. Examples of the upper limit of the content of the 1-kestose relative to the total amount of sugars can include 99% or less, 95% or less, 90% or less, 85% or less, 80% or less, 75% or less, 70% or less, or 60% or less, preferably 55% or less, 50% or less, or 45% or less, more preferably 40% or less.

In the sugar solution of the present invention, examples of the lower limit of the content of glucose relative to the total amount of sugars can include 1% or more, preferably 2% or more, 3% or more, or 4% or more, more preferably 5% or more. Examples of the upper limit of the content of the glucose relative to the total amount of sugars can include 50% or less, preferably 45% or less, 40% or less, or 35% or less, more preferably 30% or less or 25% or less.

In the present invention, the phrase “contain no fructose or have a small content thereof” means that the content of fructose relative to the total amount of sugars in the sugar solution is 0% or a considerably small value. Specific examples of the content of the fructose relative to the total amount of sugars can include 0% or more and 30% or less, 0% or more and 25% or less, 0% or more and 20% or less, 0% or more and 15% or less, and 0% or more and 10% or less.

In the present invention, the phrase “contain no nystose or have a small content thereof” means that the content of nystose relative to the total amount of sugars in the sugar solution is 0% or a considerably small value. Specific examples of the content of the nystose relative to the total amount of sugars can include 0% or more and 1.5% or less, 0% or more and 2.0% or less, 0% or more and 2.5% or less, 0% or more and 3.0% or less, 0% or more and 3.5% or less, 0% or more and 4.0% or less, 0% or more and 4.5% or less, 0% or more and 5.0% or less, 0% or more and 5.5% or less, 0% or more and 6.0% or less, 0% or more and 6.5% or less, 0% or more and 7.0% or less, 0% or more and 7.5% or less, 0% or more and 8.0% or less, 0% or more and 8.5% or less, 0% or more and 9.0% or less, 0% or more and 9.5% or less, and 0% or more and 10.0% or less.

In the present invention, the phrase “contain no maltose or have a small content thereof” means that the content of maltose relative to the total amount of sugars in the sugar solution is 0% or a considerably small value. Specific examples of the content of the maltose relative to the total amount of sugars can include 0% or more and 0.3% or less, 0% or more and 0.25% or less, 0% or more and 0.2% or less, 0% or more and 0.15% or less, and 0% or more and 0.1% or less.

The sugar solution of the present invention can be produced by a method known to those skilled in the art. One example of such a method can include a method of dissolving sucrose, 1-kestose and glucose in a solvent such as sterilized water so as to attain the contents described above, as shown in Example 6 mentioned later. Fructose, nystose and maltose may be contained in the sugar solution as long as their contents fall within a considerably small range relative to the total amount of sugars. Alternatively, none of fructose, nystose and maltose may be contained therein. Sucrose, 1-kestose, glucose, fructose, nystose and maltose are commercially available as reagents or foods. In the present invention, such commercially available products can be used.

The sugar solution of the present invention can also be produced through the enzyme reaction of fructosyltransferase (β-fructofuranosidase) with sucrose as a substrate, as shown in Example 1 mentioned later. This method can be divided into steps (i) to (iv): (i) culture of a microorganism expressing fructosyltransferase, (ii) enzyme reaction, (iii) deactivation of the enzyme, and (iv) purification of the sugar solution.

As for the step (i), examples of the microorganism expressing fructosyltransferase can include: bacteria such as Beijerinckia indica subsp. indica ATCC9039 and Burkholderia phymatum STM815; fungi such as Aspergillus kawachii 4303, Aspergillus niger ACE-2-1 (FERM P-5886), Aspergillus niger APC-9319 (deposition No.: FERM BP-7680), Aspergillus niger var. awamori JCM2261 (FERM P-13866), Fusarium lini IAM5008, Gloeosporium kaki IAM5011, and Aureobasidium pullulans var melanigenum A-8 (ATCC20612, FERM-P5885); and yeasts such as Saccharomyces cerevisiae.

The culture of the microorganism can be performed using an appropriate medium and culture conditions according to each microorganism. For example, Aureobasidium pullulans var melanigenum A-8 (ATCC20612, FERM-P5885) is cultured for 24 to 96 hours with aerated stirring at 25 to 30° C., 240 rpm, and 50 VVm using a medium of pH 6.5 containing 10% sucrose, 1% peptone, 0.7% meat extracts, 0.3% sodium chloride, and 0.1% cobalt chloride hexahydrate. The cultures are centrifuged, and precipitates are collected to obtain microbial cells expressing fructosyltransferase as a crude enzyme.

Next, the enzyme reaction in the step (ii) is performed by adding the crude enzyme to an aqueous sucrose solution. In this context, the sucrose concentration of the aqueous sucrose solution is set to 5 to 70%, preferably 30 to 60%. The reaction pH and the reaction temperature differ depending on the origin of the enzyme and are set to pH 4.0 to 7.0 and a temperature of 25 to 65° C., preferably 50 to 60° C. The enzyme concentration is set to 5 to 200 units, preferably 2.0 to 80 units, per g of sucrose. As for the unit of the enzyme, the amount of the enzyme producing 1 μmol of glucose into a reaction solution (a total of 2.5 mL) when 1.0 mL of a buffer solution of pH 5.0 and 0.5 mL of the enzyme solution are added to 1.0 mL of a 5% sucrose solution and reacted at 40° C. for 60 minutes, is defined as 1 unit.

Next, the deactivation of the enzyme in the step (iii) is performed by heating the reaction solution at 100° C. for approximately 10 minutes. This terminates the enzyme reaction. Finally, the purification of the sugar solution in the step (iv) is performed by filtering the reaction solution for the removal of microbial cell components, then decolorizing the filtrate with active carbon, and further purifying the resultant by desalting with an ion-exchange resin to obtain a sugar solution.

When the contents of sucrose, 1-kestose, glucose, fructose, nystose and maltose in the sugar solution produced through enzyme reaction fall outside the ranges of the sugar solution of the present invention, the contents can be adjusted to these ranges by adding sucrose, 1-kestose and/or glucose to the sugar solution, or by removing fructose, nystose and/or maltose from the sugar solution. In this context, the removal of fructose, nystose and/or maltose can be performed by a method known to those skilled in the art. Examples of such a method can include a method of subjecting the sugar solution to a chromatographic separation method to separate a fructose-containing fraction, a nystose-containing fraction and/or a maltose-containing fraction, as disclosed in Japanese Patent Publication No. 2000-232878.

In the present invention, the types of the sugars contained in the sugar solution, and their contents can be measured by a method known to those skilled in the art. Examples of such a method can include a method of subjecting the sugar solution to high-performance liquid chromatography (HPLC) equipped with a column for sugar analysis (column for ligand-exchange chromatography) to separate sugar components, which are detected in a differential refractive index detector to obtain a chromatogram, as shown in Example 1 mentioned later. Various commercially available monosaccharide and oligosaccharide reagents can be used as standard samples in the HPLC measurement.

In the sugar solution of the present invention, the sugar concentration (sugar level) is not particularly limited and can be appropriately set according to the purpose of the sugar solution, etc. The Brix sugar level as measured at 20° C. with a commercially available sugar refractometer is preferably 60 degrees or more, more preferably 65 degrees or more, further preferably 70 degrees or more, from the viewpoint of the prevention of putrefaction.

As shown in Examples mentioned later, it has been revealed for the sugar solution of the present invention that crystal precipitation is suppressed in a low-temperature environment. Specifically, the sugar solution of the present invention can have physical properties of precipitating no sugar crystal even under refrigeration at 4° C. for 21 days when the Brix sugar level as measured by a sugar refractometer is set to 75 degrees, as shown in Example 2, or can have physical properties of precipitating no sugar crystal even under refrigeration at 4° C. for 36 days when the Brix sugar level is set to 70 degrees, as shown in Example 6(5).

As shown in Examples mentioned later, it has been revealed for the sugar solution of the present invention that the viscosity is not too high in a low-temperature environment and an appropriate viscosity can be maintained. Specifically, the sugar solution of the present invention can have physical properties of having a viscosity at 5° C. of 15000 mPa·s or less as measured at 200 rpm by a rotational viscometer when the Brix sugar level as measured by a sugar refractometer is set to 75 degrees, as shown in Example 4.

The sugar solution according to the present invention can be used as, for example, a liquid sweetener. Specifically, the present invention also provides a liquid sweetener which is prepared using the sugar solution according to the present invention, and a method for producing a sweetened food or beverage using the liquid sweetener. This production method comprises the step of adding the sugar solution according to the present invention as a liquid sweetener to a food or a beverage to sweeten the food or the beverage (addition step).

As shown in Example 5 mentioned later, it has been revealed that the liquid sweetener which is prepared using the sugar solution of the present invention neither precipitates crystals nor extremely increases its viscosity when added to foods and beverages having a low temperature, and can maintain excellent qualities and handling properties even in a low-temperature environment.

Thus, the food or the beverage to which the liquid sweetener is to be added in the addition step may be a food or a beverage which is preserved at 0° C. or higher and 10° C. or lower. Examples of the food or the beverage which is preserved at 0° C. or higher and 10° C. or lower can generally include foods and beverages to be refrigerated and can specifically include: dairy products such as milk, processed milk, milk beverages, condensed milk, fermented milk (yogurt), and lactic acid bacteria beverages; beverages such as milk, soft drinks, tea, coffee, and cocoa; confectionery such as unbaked cake, half-dry confectionery, and Japanese cake; and others such as meat products, soups, prepared foods, processed vegetable products, processed fruit products, vegetables, fruits, meats, and fishes.

The sugar solution according to the present invention can also be used as a bee feed. Specifically, the present invention also provides a bee feed which is prepared using the sugar solution according to the present invention, and a method for breeding a bee using the bee feed. This breeding method comprises the step of providing the sugar solution according to the present invention as a bee feed to the bee (feeding step).

In this context, the “bee” according to the present invention refers to, among insects belonging to the superfamily Apoidea of the order Hymenoptera, an insect having the habit of going to flowers and collecting nectars or pollens. Specific examples of the bee can include honeybees (bees belonging to the genus Apis), bumblebees (bees belonging to the genus Bombus), carpenter bees (bees belonging to the subfamily Xylocopinae), stingless honeybees (bees belonging to the genus Meliponini), and mason bee (bees belonging to the genus Osmia).

In the feeding step, the bee feed which is prepared using the sugar solution according to the present invention can be provided to the bee in the same way as in conventional bee feeds. Specifically, the sugar solution can be put in an appropriate container such as a feeder, which is then placed in or near a hive. The feeder is preferably a shallow container so as to prevent bees from drowning in the sugar solution. Thus, for example, a glass or resin container having a smooth surface should be avoided, and a feeder made of wood or the like is preferred. It is also preferred to put scaffolding such as a disposable chopstick, a small branch, or a rope in the container.

Other components may be added to the sugar solution according to the present invention as long as the features of the present invention are not impaired. In the case of using the sugar solution as a liquid sweetener, examples of additives can include colorants, preservatives, thickeners, stabilizers, gelling agents, starch adhesives, antioxidants, acidulants, and flavors. In the case of using the sugar solution as a bee feed, examples of additives can include commercially available pollen substitutes, pollens, pollen substitutes such as soybean powders, casein, and brewer's yeast, vitamins, minerals, amino acids, and bee attractants (Cymbidium floribundum and its components, Nasonov pheromone, honey, etc.). In the case of the sugar solution as a bee feed, its form is not particularly limited and may be any form, for example, a solid form such as a powder or a mass, a paste form, or a liquid form.

Hereinafter, the present invention will be described with reference to each Example. The technical scope of the present invention is not limited by features shown by these Examples. In these Examples, the sugar level of each sugar solution was measured at 20° C. by a sugar refractometer and is indicated by Brix sugar level with the unit “degree”.

### EXAMPLES

### <Example 1> Production of Sugar Solution and Confirmation of Sugar Composition

The enzyme reaction of fructosyltransferase was performed with sucrose as a substrate in accordance with the method described in Japanese Patent Publication No. 59-53834 (p. 2-3) and Japanese Patent Publication No. 2010-273580 (paragraph [0096]) to produce a sugar solution containing oligosaccharides, which was designated as sugar solution 1. Specifically, Aspergillus niger ACE-2-1 (deposition No.: FERM P-5886) was first inoculated to an enzyme production medium (5% sucrose, 0.7% malt extracts, 1% polypeptone, 0.5% carboxymethylcellulose, and 0.3% NaCl) and cultured at 28° C. for 3 days, followed by the ultrasonic disruption of microbial cells to prepare a crude enzyme solution. To a 45% aqueous sucrose solution (pH 7.5), the crude enzyme solution was added at a ratio of 2.5 units per g of sucrose and reacted at 40° C. for 24 hours to obtain an enzyme reaction solution. The enzyme reaction solution was heated at 100° C. for 10 minutes to terminate the enzyme reaction. Then, the reaction solution was filtered, and the filtrate was collected. The filtrate was decolorized with active carbon by a standard method and further desalted with an ion-exchange resin. The resultant was used as sugar solution 1.

Also, 100 g of granulated sugar was dissolved in 100 g of sterilized water. Then, the Brix sugar level was adjusted to near 75 degrees by heating to prepare a sucrose syrup, which was designated as sugar solution 2. Furthermore, commercially available isomerized liquid sugar “High Fructoka (Kato Kagaku Co., Ltd.)”, and commercially available honey “Sakura Pure Honey (Kato Brothers Honey Co., Ltd.)” and “Seven Premium Pure Honey (Kato Brothers Honey Co., Ltd.)”) were provided and designated as sugar solutions 3 to 5.

The sugar solutions 1 to 5 were subjected to high-performance liquid chromatography (HPLC) under conditions described below to confirm sugar composition (the types of monosaccharides and oligosaccharides contained in the sugar solutions, and their contents). The content of each sugar was calculated in percentage as the ratio of the area of each peak to the total area of all peaks detected. The results are shown in Table 1. In Table 1, “-” represents equal to or lower than the detection limit (0.1% or less).

<<HPLC Conditions>>

Column: Shodex SUGAR KS-802 HQ (8.0 mm ID×300 mm), two columns
Eluent: highly pure water
Flow rate: 1.0 mL/min
Column temperature: 50° C.
Injection volume: 200 μL
Detection: differential refractive index detector Shodex RI

TABLE 1

| | | | Sugar solution 3 | | |
|---|---|---|---|---|---|
| | | | (commercially | Sugar solution 4 | Sugar solution 5 |
| | | Sugar solution 2 | available isomerized | (commercially | (commercially |
| | Sugar solution 1 | (sucrose syrup) | liquid sugar) | available honey) | available honey) |
| Sucrose | 60 | 100 | — | 1.3 | 1.8 |
| 1-Kestose | 19 | — | — | — | — |
| Glucose | 13 | — | 38 | 42 | 41 |
| Fructose | 5 | — | 57 | 49 | 50 |
| Nystose | 1 | — | — | — | — |
| Maltose | — | — | — | 5.6 | 4.5 |
| Other oligosaccharides/ | 2 | — | 5 | 2.1 | 2.7 |
| monosaccharides | | | | | |
| Total | 100 | 100 | 100 | 100 | 100 |

As shown in Table 1, the sugar solution 1 had unique sugar composition different from that of the sugar solutions 2 to 5 in that the sugar solution 1 contained approximately 30 to 70% sucrose as the first component having the largest content relative to the total amount of sugars, approximately 10 to 40% 1-kestose as the second component having the second largest content, and approximately 5 to 30% glucose as the third component having the third largest content, and contained none of fructose, nystose and maltose or had small contents thereof. Accordingly, this result revealed that the sugar solution 1 has unique sugar composition different from that of a sucrose syrup or a commercially available liquid sweetener.

### <Example 2> Crystal Precipitation Suppressive Effect

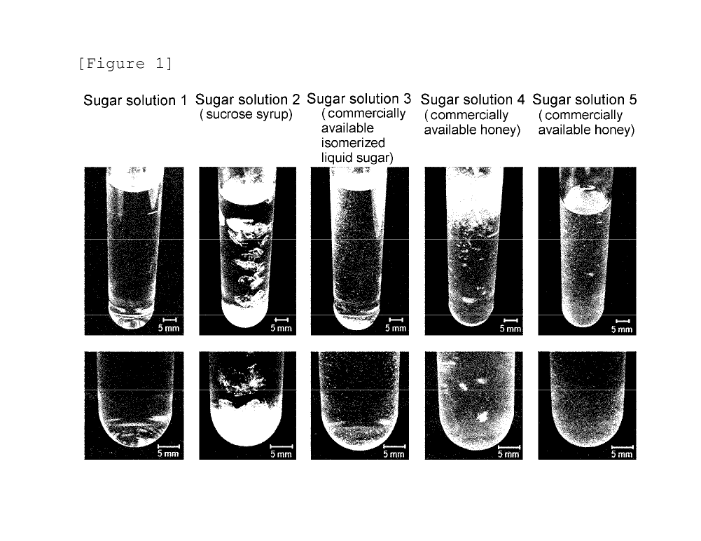

The Brix sugar level was adjusted to near 75 degrees as to the sugar solutions 1 to 5 of Example 1. Then, 12 g of each solution was weighed and put in a test tube. The resultant was refrigerated at 4° C. for 21 days. Then, the presence or absence of crystal precipitation was visually confirmed. The results are shown in FIG. 1.

As shown in FIG. 1, precipitated crystals were confirmed in the sugar solutions 2 to 5, whereas no crystal was confirmed in the sugar solution 1. Furthermore, no crystal was confirmed in the sugar solution 1 even after a lapse of 21 days of the refrigeration period (data not shown). This result revealed that the sugar solution which contains sucrose, 1-kestose and glucose and contains none of fructose, nystose and maltose or has small contents thereof markedly suppresses sugar crystal precipitation in a low-temperature environment.

### <Example 3> Contents of Sucrose and 1-Kestose

The contents of the first component sucrose and the second component kestose in the sugar solution 1 of Example 1 were studied from the viewpoint of a crystal precipitation suppressive effect.

Specifically, agar-based confectionery containing 70% granulated sugar relative to a finish total weight was prepared and designated as sample 1. Also, agar-based confectionery was similarly prepared as a formulation having 1-kestose substituted for 0.1 to 15% of granulated sugar and designated as samples 2 to 9. The formulations of the samples 1 to 9 are shown in Table 2. The method for preparing each agar-based confectionery involved first adding 2.5 g of powder agar to 100 g of water, then adding granulated sugar, or granulated sugar and 1-kestose under heating, and dissolving the mixture by boiling. Then, while water was evaporated, the solution was concentrated until the finish total weight became 225.7 g. The resultant was poured at 8 g/mold to a silicon mold (2.5 cm long×2.5 cm wide×0.8 cm deep) before decrease in temperature, and allowed to cool to prepare the agar-based confectionery.

TABLE 2

| | Sample 1 | Sample 2 | Sample 3 | Sample 4 | Sample 5 | Sample 6 | Sample 7 | Sample 8 | Sample 9 |
|---|---|---|---|---|---|---|---|---|---|
| Granulated sugar (g) | 158 | 157.84 | 157.21 | 156.4 | 154.84 | 153.26 | 150.1 | 142.2 | 134.3 |
| 1-Kestose (g) | 0 | 0.16 | 0.79 | 1.6 | 3.16 | 4.74 | 7.9 | 15.8 | 23.7 |
| Powder agar (g) | 2.5 | 2.5 | 2.5 | 2.5 | 2.5 | 2.5 | 2.5 | 2.5 | 2.5 |
| Water (g) | 100 | 100 | 100 | 100 | 100 | 100 | 100 | 100 | 100 |
| Total weight at the time | 260.5 | 260.5 | 260.5 | 260.5 | 260.5 | 260.5 | 260.5 | 260.5 | 260.5 |
| of formulation (g) | | | | | | | | | |
| Total weight at the time of | 225.7 | 225.7 | 225.7 | 225.7 | 225.7 | 225.7 | 225.7 | 225.7 | 225.7 |
| finish (g) | | | | | | | | | |
| Substitution rate of granulated | 0% | 0.1% | 0.5% | 1% | 2% | 3% | 5% | 10% | 15% |
| sugar by 1-kestose (mass %) | | | | | | | | | |
| Sucrose:1-kestose | 158:0 | 1973:2 | 15721:79 | 391:4 | 3871:79 | 97:3 | 1501:79 | 711:79 | 17:3 |
| (parts by weight) | | | | | | | | | |

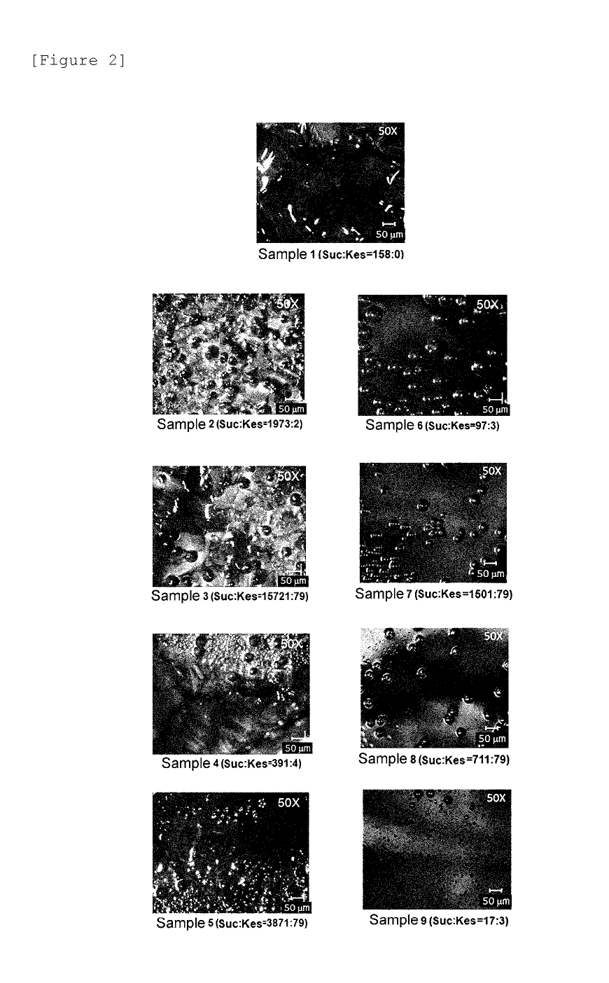

Subsequently, the samples 1 to 9 were refrigerated at 4° C. for 21 days. Then, the presence or absence of crystal precipitation on the agar-based confectionery surface was confirmed under an optical microscope (Keyence Corp.). The results are shown in FIG. 2.

On the first day of refrigeration, no crystal was confirmed in any of the samples 1 to 9 (data not shown). On the other hand, as shown in FIG. 2, large precipitated crystals were confirmed in the samples 1 to 5 on the 21st day of refrigeration. By contrast, no crystal was confirmed in the samples 6 to 9 on the 21st day of refrigeration, as in the first day. This revealed that sugar crystal precipitation is suppressed when the ratio of 1-kestose to sucrose is larger than that of the sample 6 (sucrose: 1-kestose=97:3). This result revealed that sugar crystal precipitation can be suppressed by allowing a sugar solution to contain 3 parts by weight or more of 1-kestose per 97 parts by weight of sucrose.

### <Example 4> Viscosity

The Brix sugar level was adjusted to near 75 degrees as to the sugar solutions 1 to 5 of Example 1. Then, their viscosities were measured at normal temperature (20° C.). Also, each sugar solution was refrigerated at a low temperature (5° C.) for 1 hour, and the viscosity was then measured at 5° C. The viscosities were measured by putting 20 mL of each sugar solution in a low viscosity adapter of “Brookfield rotational viscometer DV2T HB”, and attaching spindle ULA(0) thereto, followed by viscosity measurement at the number of rotations of 200 rpm in a circulatory thermostat having each temperature (20° C. or 5° C.). The measurement values of the viscosities are shown in Table 3, and a bar graph of these measurement values is shown in FIG. 3.

TABLE 3

| | | | Sugar solution 3 | | |
|---|---|---|---|---|---|
| | | | (commercially | Sugar solution 4 | Sugar solution 5 |
| Viscosity | | Sugar solution 2 | available isomerized | (commercially | (commercially |
| (mPa · s) | Sugar solution 1 | (sucrose syrup) | liquid sugar) | available honey) | available honey) |
| Normal temperature | 2000 | 200 | 800 | 11900 | 9300 |
| (20° C.) | | | | | |
| Low temperature | 13200 | 8200 | 4800 | 91700 | 190000 |
| (5° C.) | | | | | |

As shown in Table 3 and FIG. 3, the viscosity at 20° C. was less than 12000 mPa·s for all of the sugar solutions 1 to 5. On the other hand, the viscosity at 5° C. was 91700 mPa·s and 190000 mPa·s for the sugar solution 4 and the sugar solution 5, respectively, and was markedly large. By contrast, the viscosity at 5° C. was 13200 mPa·s or less for the sugar solutions 1 to 3.

As is evident in light of the general viscosity of yogurt on the order of 10³ to 10⁴ mPa·s, the viscosities at 5° C. of the sugar solution 4 and the sugar solution 5 are markedly high. Thus, these sugar solutions are difficult to take out of containers in a low-temperature environment and also difficult to add dropwise and are therefore inferior in handling properties. When a subject to which such a sugar solution is to be added has a low temperature, the sugar solution is difficult to mix with the subject due to rapid elevation in the viscosity of the sugar solution and is thus also inferior in handling properties.

By contrast, the viscosities of the sugar solution 1, the sugar solution 2 and the sugar solution 3 in a low-temperature environment are equivalent to or smaller than the viscosity of yogurt. Thus, these sugar solutions are easy to take out of containers even in a low-temperature environment and also easy to add dropwise and therefore have excellent handling properties. Even when a subject to which such a sugar solution is to be added has a low temperature, the sugar solution is easy to mix with the subject because of the absence of rapid elevation in the viscosity of the sugar solution and thus also has excellent handling properties.

These results revealed that the sugar solution which contains sucrose, 1-kestose and glucose, and contains none of fructose, nystose and maltose or has small contents thereof can maintain an appropriate viscosity even in a low-temperature environment and has excellent handling properties upon use in a low-temperature environment.

### <Example 5> Study on Purpose of Sugar Solution; Liquid Sweetener

The sugar solution 1 of Example 1 was added as a liquid sweetener to yogurt and subjected to a sensory test. Specifically, the sugar solution 1 was added at a ratio of 10 g to 75 g of yogurt “Bichidas plain yogurt (Morinaga Milk Industry Co., Ltd.)” preserved at 4° C. and mixed using a spoon to prepare an evaluation sample. Also, a control sample was prepared without the addition of the sugar solution 1. Eight analytical panelists ate the evaluation sample and the control sample and evaluated 3 items: the “degree of suppression of sourness”, the “degree of suppression of astringency” and the “smoothness of texture”. Each panelist judged and graded each evaluation item on five scales: “very strong (5), strong (4), equivalent (3), slightly weak (2), and weak (1)” with the control sample as a comparative control (3). Then, an average of the grading results of all the panelists was determined. The results are shown in Table 4.

TABLE 4

| | Control sample | Evaluation sample |
|---|---|---|
| | (yogurt non- | (yogurt |
| | supplemented with | supplemented with |
| | sugar solution 1) | sugar solution 1) |
| Degree of suppression of | 3 | 4 |
| sourness | | |
| Degree of suppression of | 3 | 4.6 |
| astringency | | |
| Smoothness of texture | 3 | 4.8 |

As shown in Table 4, the degree of suppression of sourness was 4 for the evaluation sample with respect to 3 for the control sample. The degree of suppression of astringency was 4.6 for the evaluation sample with respect to 3 for the control sample. The smoothness of texture was 4.8 for the evaluation sample with respect to 3 for the control sample. Specifically, the yogurt supplemented with the sugar solution 1 showed suppressed sourness and astringency, enhanced smoothness of texture, and good taste, as compared with the yogurt non-supplemented with the sugar solution 1. This result revealed that the sugar solution which contains sucrose, 1-kestose and glucose, and contains none of fructose, nystose and maltose or has small contents thereof is usable as a liquid sweetener capable of imparting an excellent flavor to foods and beverages.

The sugar solution 1, when added to yogurt of a low temperature neither precipitated crystals nor extremely increased its viscosity, and was easily mixed and blended into the yogurt (data not shown). This result revealed that the sugar solution which contains sucrose, 1-kestose and glucose, and contains none of fructose, nystose and maltose or has small contents thereof is usable as a liquid sweetener having excellent qualities and handling properties in a low-temperature environment.

### <Example 6> Study on Purpose of Sugar Solution; Bee Feed

### (1) Confirmation of Sugar Composition of Feed

Three types of commercially available liquid honeybee feeds were provided and designated as feed A, feed B and feed C. Also, sucrose, 1-kestose, glucose, fructose and nystose were dissolved in sterilized water to prepare a sugar solution containing sucrose, 1-kestose and glucose, having a small content of nystose, and containing 3 parts by weight or more of 1-kestose per 97 parts by weight of sucrose (sugar level: 70.8 degrees), which was designated as feed D. The feeds A to D were subjected to HPLC under the conditions described in Example 1 to confirm sugar composition. The results are shown in Table 5.

TABLE 5

| | Feed A | Feed B | Feed C | Feed D |
|---|---|---|---|---|
| | (75.4° Bx) | (63.9° Bx) | (69.9° Bx) | (70.8° Bx) |
| Sucrose | 33.6 | — | 50.3 | 63.1 |
| 1-Kestose | — | — | — | 18.8 |
| Glucose | 29.3 | 51.3 | 18.4 | 13.3 |
| Fructose | 26.2 | 48.7 | 15.2 | 4.1 |
| Nystose | 0.0 | 0.0 | 0.0 | 0.0 |
| Maltose | 0.0 | 0.0 | 0.0 | 0.0 |
| Other oligosaccharides/ | 10.9 | — | 16.1 | 0.7 |
| monosaccharides | | | | |
| Total | 100.0 | 100.0 | 100.0 | 100.0 |

As shown in Table 5, only the feed D was found to have the unique sugar composition of containing sucrose, 1-kestose and glucose, containing 3 parts by weight or more of 1-kestose per 97 parts by weight of sucrose, and containing none of fructose, nystose and maltose or having small contents thereof. Particularly, the unique composition was revealed because the feed A, the feed B and the feed C contained no 1-kestose while only the feed D contained 1-kestose.

### (2) Confirmation of Shelf Life of Feed

The feeds A to D were examined for the proliferation of a yeast, one of hygiene indicator microorganisms in foods, to confirm a shelf life. Specifically, the yeast was first isolated. Specifically, commercially available American-grown raisin was put in sterilized water and left standing at 22° C. for 3 days to obtain a culture solution. This culture solution was streak-cultured repetitively several times using YM agar medium (composition; 10 g of glucose (Wako Pure Chemical Industries, Ltd.), 5 g of peptone (BD Biosciences), 3 g of yeast extracts (BD Biosciences), 3 g of malt extracts (BD Biosciences), 1 L of distilled water, and 20 g of agar (Wako Pure Chemical Industries, Ltd.), pH unadjusted). A colony which had yeast-like appearance (small colony, clear colony edge, cream or yellowish brown color, raised colony, the absence of a dark spot (core) at the center of the colony, etc.) and was confirmed to be germinated by microscopic observation, was separated and selected as a yeast for use in the test given below. The yeast was inoculated to YM liquid medium (composition; the same as that of the YM agar medium except that agar was excluded) on the day before the test day, and shake-cultured overnight at 25° C. until the OD (optical density) value at 600 nm became approximately 4.0, to obtain a yeast culture solution. The yeast culture solution was diluted 20,000-fold with sterilized water. The resultant was used as a yeast solution.

### [2-1] Comparison Among Feeds A to D

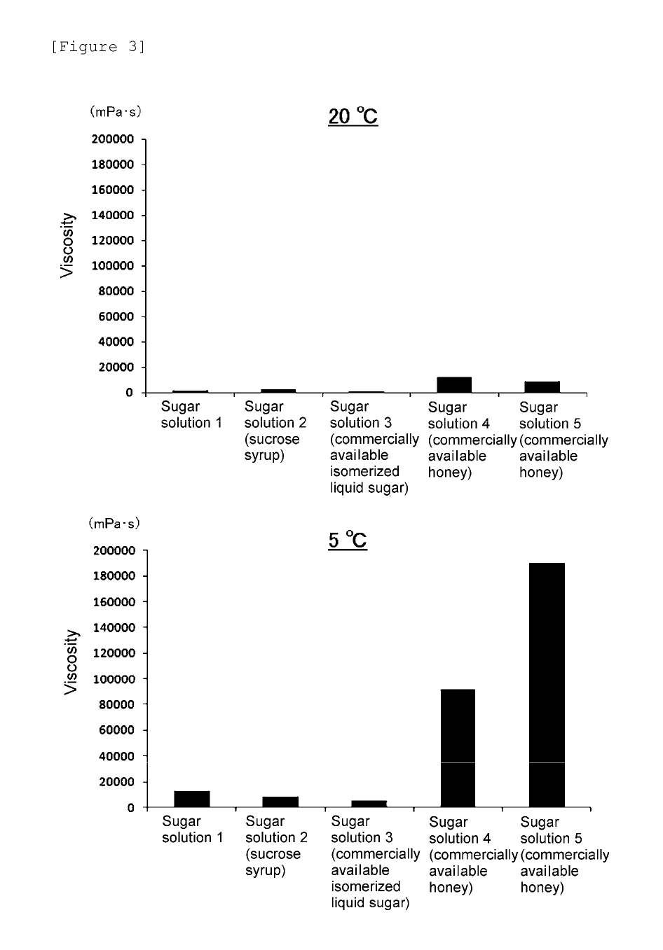

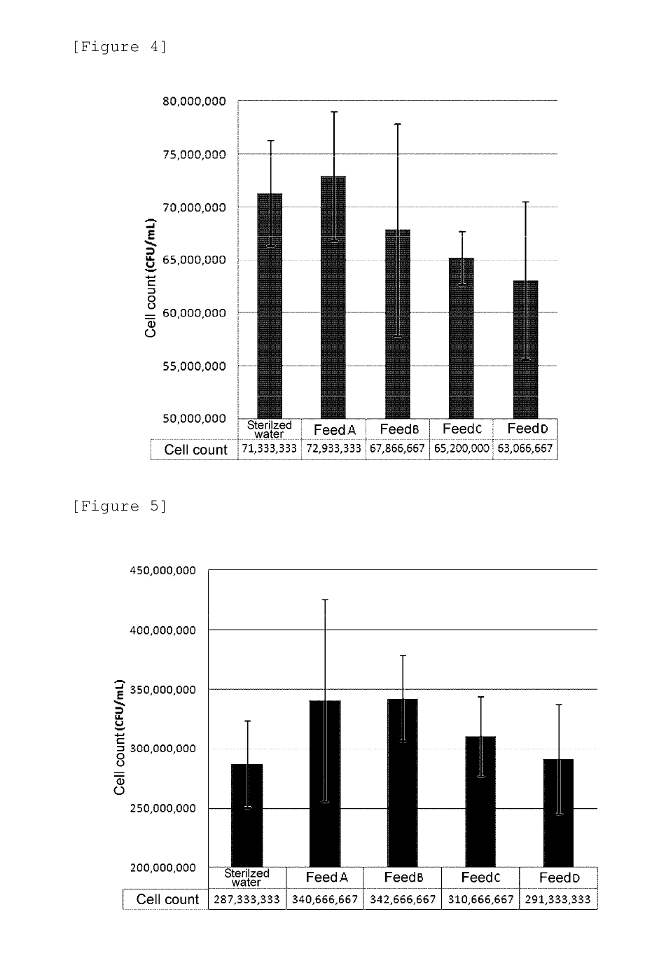

The feeds A to D were diluted 5-fold with sterilized water and filtered through a filter having a pore size of 0.22 μm. The filtrates were collected and used as feed specimens. Sterilized water was provided as a comparative control. Three YM agar media were prepared per feed specimen in petri dishes having a diameter of 10 cm. Each medium was uniformly coated with 500 μL of the feed specimen or sterilized water, and dried. Subsequently, the medium was uniformly coated with 50 μL of the yeast solution, and dried. Then, the yeast was cultured at 25° C. for 2 days, and the number of colonies that appeared was counted. A mean and standard deviation of the three petri dishes per feed specimen were calculated. On the basis of the calculation results, a mean and standard deviation of cell counts (CFU/mL) were calculated for the feeds A to D and indicated by graph. The results are shown in FIG. 4.

As shown in FIG. 4, the feed D had the smallest cell count as compared with sterilized water and the feeds A to C, revealing that the feed D resists the proliferation of the yeast. This result revealed that the sugar solution containing 1-kestose is usable as a bee feed having the slow progression of putrefaction and a long shelf life.

### [2-2] Comparison Among Feeds A to D Equalized in Terms of Sugar Level

In order to test the influence of a sugar level on a shelf life, the degree of yeast proliferation was examined among feeds A to D equalized in terms of a sugar level (Brix). Specifically, the feeds A to D were all diluted into 30 degrees with sterilized water.

Subsequently, these feeds were diluted 2-fold with sterilized water and then filtered through a filter having a pore size of 0.22 μm. The filtrates were collected and used as feed specimens. Sterilized water was provided as a comparative control. Subsequently, colonies were cultured on YM agar media by the method described in Example 6(2) [2-1], and the number thereof was counted and indicated by graph. The yeast culture solution of Example 6(2) was diluted 100,000-fold with sterilized water and used instead of the yeast solution. The results are shown in FIG. 5.

As shown in FIG. 5, the feed D had the smallest cell count as compared with the feeds A to C, in spite of the fact that these feeds were equalized in terms of a sugar level. This result suggested that the effect of “having a long shelf life” for the feed D is not ascribable to a sugar level, but is attributed to its unique sugar composition. These results revealed that the sugar solution containing 1-kestose is usable as a bee feed having the slow progression of putrefaction and a long shelf life.

(3) Confirmation of Bee's Preference; Comparison with Sugar Solution Containing Only 1-Kestose

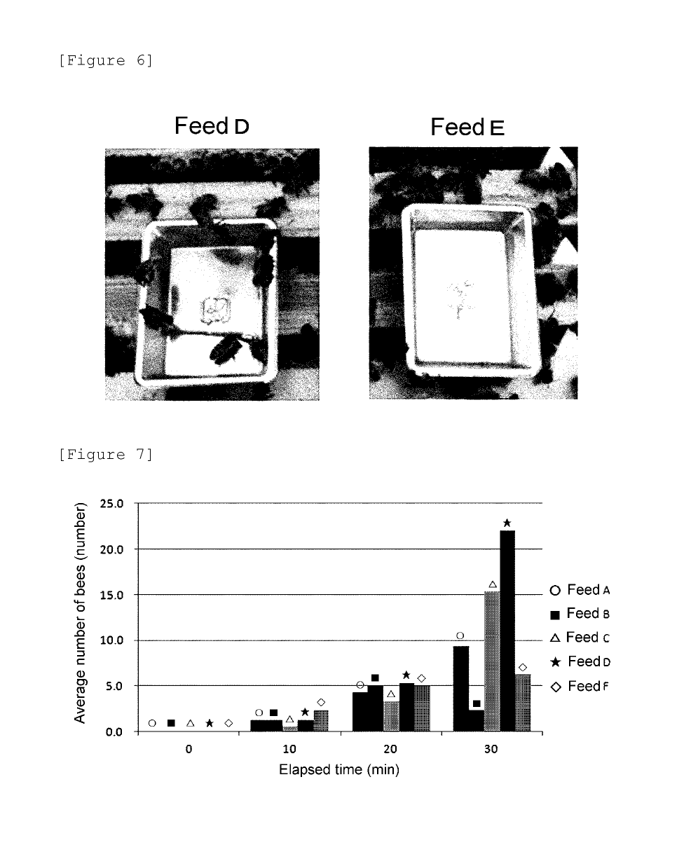

A bee's preference was confirmed as to a sugar solution containing, as a soluble solid, only “1-kestose”, a component found to be unique to the feed D in Example 6(1). Specifically, 1-kestose was first dissolved into 60 degrees in sterilized water. This solution was designated as feed E. Feed D was provided as a comparative control. These feeds were put at 5 mL/container in 55 mm×75 mm rectangular containers, which were then disposed on the hive frames of beekeeping boxes (approximate 8000 bees/box). After a lapse of 10 minutes, photographs were taken. On the basis of the taken photographic images, the number of honeybees present in the container of each feed was counted. The results are shown in FIG. 6.

As shown in FIG. 6, the number of bees 10 minutes later was 8 for the feed D and 0 for the feed E. Specifically, the sugar solution containing only 1-kestose attracted no honeybee, whereas the sugar solution containing 1-kestose as well as an oligosaccharide other than 1-kestose and/or a monosaccharide attracted honeybees. This result revealed that bees more preferentially ingest the sugar solution containing 1-kestose as well as an oligosaccharide other than 1-kestose and/or a monosaccharide as soluble solids (high bee's preference).

(4) Confirmation of Bee's Preference; Comparison with Commercially Available Feed

### [4-1] Counting of the Number of Bees

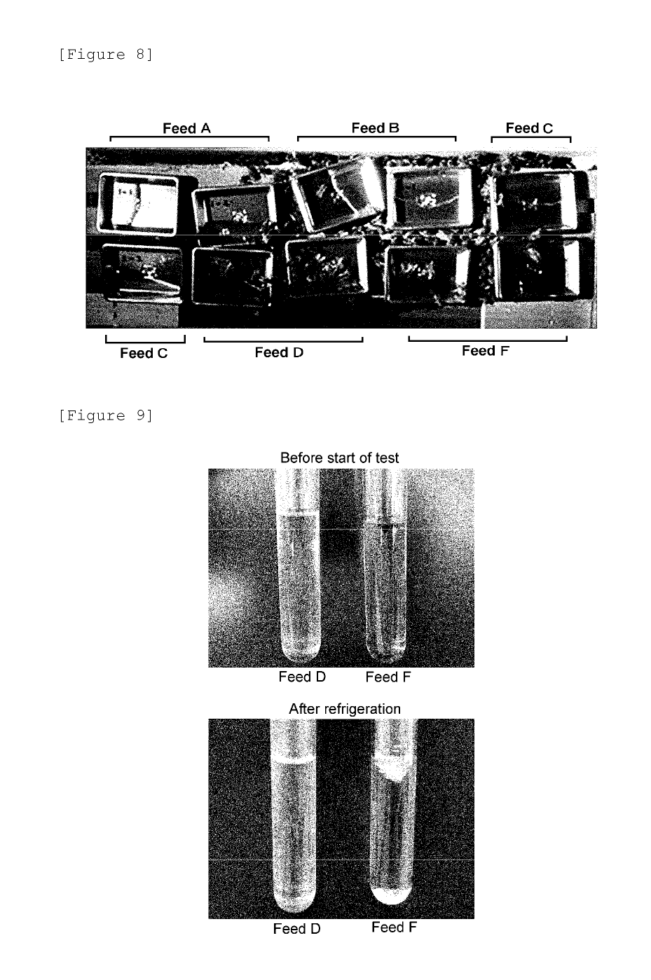

A commercially available liquid honeybee feed “Japan Beekeeping Association Liquid Sugar” (Japan Beekeeping Association) (sugar composition: 100% sucrose) was provided and designated as feed F. Feeds A to D were also provided. The same experiment as that of Example 6(3) was conducted using these feeds. However, two containers containing each feed were disposed per feed. The number of bees was counted after a lapse of 10 minutes, 20 minutes and 30 minutes. The same test was conducted on three beekeeping boxes (approximately 8000 bees/box). On the basis of the measurement results, the average number of bees was calculated. The results are shown in Table 6 and FIG. 7. A typical photographic image after a lapse of 30 minutes is shown in FIG. 8.

TABLE 6

| | Feed A | Feed B | Feed C | Feed D | Feed F |
|---|---|---|---|---|---|
| Measurement time | Average number of bees (number) | | | | |
| Immediately after start | 0.0 | 0.0 | 0.0 | 0.0 | 0.0 |
| 10 minutes later | 1.3 | 1.3 | 0.7 | 1.3 | 2.3 |
| 20 minutes later | 4.3 | 5.0 | 3.3 | 5.3 | 5.0 |
| 30 minutes later | 9.3 | 2.3 | 15.3 | 22.0 | 6.3 |

As shown in Table 6 and FIGS. 7 and 8, the average number of bees 30 minutes later was 9.3 for the feed A, 2.3 for the feed B, 15.3 for the feed C, 22 for the feed D, and 6.3 for the feed F. The largest number of bees 30 minutes later was 36 for the feed D. Specifically, the number of honeybees attracted by the feed D which was the sugar solution of Example 6 according to the present invention was markedly large as compared with the feeds A to C and F which were commercially available honeybee feeds. This result revealed that the sugar solution containing 1-kestose and an oligosaccharide other than 1-kestose and/or a monosaccharide is usable as a bee feed having a markedly high bee's preference.

### [4-2] Measurement of Amount of Feed Remaining

Feeds A to D and F were provided. Two feeders containing 500 mL of each feed were provided per feed and designated as feed A-1 and feed A-2 (the same holds true for the description below). Also, 100 to 500 mL of each feed was put in feeders of the same type as that used in the test. A water level was measured on a 100-mL basis, and the calibration mark of the water level was written on a wooden board to prepare a counter rod. Each feeder was disposed in a hive (approximately 6200 to 6700 bees/group) at a ratio of one feeder to one hive. After a lapse of 4 to 8 hours and after a lapse of 24 hours, the amount of each feed remaining was confirmed using the counter rod. The results are shown in Table 7. In Table 7, “Remining” means that the feed was visually confirmed to remain though the remining amount was not measured.

TABLE 7

| | Feed A | | Feed B | | Feed C | | Feed D | | Feed F | |
|---|---|---|---|---|---|---|---|---|---|---|
| | A-1 | A-2 | B-1 | B-2 | C-1 | C-2 | D-1 | D-2 | F-1 | F-2 |
| Measurement time | Amount of feed remaining (mL) | | | | | | | | | |
| Before start | 500 | 500 | 500 | 500 | 500 | 500 | 500 | 500 | 500 | 500 |
| 4 hours later | 350 | 280 | 400 | 420 | 490 | 410 | 100 | 100 | 200 | 420 |
| 5 hours later | (Remaining) | (Remaining) | (Remaining) | (Remaining) | (Remaining) | (Remaining) | 0 | 0 | (Remaining) | (Remaining) |
| 6 hours later | (Remaining) | 0 | (Remaining) | (Remaining) | (Remaining) | (Remaining) | 0 | 0 | (Remaining) | (Remaining) |
| 7 hours later | 0 | 0 | (Remaining) | (Remaining) | (Remaining) | (Remaining) | 0 | 0 | (Remaining) | (Remaining) |
| 8 hours later | 0 | 0 | 0 | 210 | 200 | 50 | 0 | 0 | 30 | 50 |
| 24 hours later | 0 | 0 | 0 | 0 | 0 | 0 | 0 | 0 | 0 | 0 |

As shown in Table 7, the time from the start of the test to the complete consumption (remaining amount of 0) of the feed by the ingestion by honeybees was 7 hours later for the feed A-1, 6 hours later for the feed A-2, 8 hours later for the feed B-1, and 8 or more hours later for the feed B-2, the feed C-1, the feed C-2, the feed F-1 and the feed F-2, whereas the amount of the feed remaining was markedly decreased to approximately 100 mL 4 hours later and was zero 5 hours later for the feed D-1 and the feed D-2. All of the feeds were completely consumed 24 hours later.

Specifically, the time required for the complete consumption of the feed was shortest for the feed D which was the sugar solution of Example 6 according to the present invention as compared with the feeds A to C and F which were commercially available honeybee feeds. This result revealed that the sugar solution containing 1-kestose and an oligosaccharide other than 1-kestose and/or a monosaccharide is usable as a bee feed having a markedly high bee's preference.

### (5) Confirmation of Crystal Precipitation Suppressive Effect in Feed

Feed D and feed F were provided. The sugar level of each feed was adjusted to 70 degrees using sterilized water. Then, the feed was put in a test tube and refrigerated at 4° C. for 36 days. Then, the presence or absence of crystal precipitation was visually confirmed. The results are shown in FIG. 9.

As shown in FIG. 9, large precipitated crystals were confirmed in liquid surface and the lower part of the test tube for the feed F after refrigeration. By contrast, no crystal was precipitated for the feed D even after refrigeration, as in before the start of the test. The results of Example 6(5) and Example 4 revealed that the sugar solution containing 1-kestose and an oligosaccharide other than 1-kestose and/or a monosaccharide neither precipitates crystals nor extremely increases its viscosity even in a low-temperature environment such as open air in the winter season, and is usable as a bee feed that can maintain excellent qualities and handling properties.

1. A sugar solution containing sucrose, 1-kestose and glucose, wherein the content of nystose is 0 to 6 mass % relative to the total amount of sugars, and 3 parts by weight or more of 1-kestose is contained per 97 parts by weight of sucrose.

2. A sugar solution having the following content of each sugar relative to the total amount of sugars:
30 to 70 mass % of sucrose,
10 to 40 mass % of 1-kestose,
5 to 30 mass % of glucose,
0 to 10 mass % of fructose,
0 to 6 mass % of nystose, and
0 to 0.1 mass % of maltose.

3. The sugar solution according to claim 1, wherein a Brix sugar level as measured by a sugar refractometer is 70 degrees or more.

4. The sugar solution according to claim 1, wherein the sugar solution has physical properties of precipitating no sugar crystal even under refrigeration at 4° C. for 21 days when the Brix sugar level as measured by a sugar refractometer is 75 degrees.

5. The sugar solution according to claim 1, wherein the sugar solution has physical properties of having a viscosity at 5° C. of 15000 mPa·s or less as measured at 200 rpm by a rotational viscometer when the Brix sugar level as measured by a sugar refractometer is 75 degrees.

6. A liquid sweetener prepared using a sugar solution according to claim 1.

7. A bee feed prepared using a sugar solution according to claim 1.

8. A method for producing a sweetened food or beverage, comprising the step of adding a liquid sweetener according to claim 6 to a food or a beverage.

9. The production method according to claim 8, wherein the food or the beverage is a food or a beverage to be preserved at 0° C. or higher and 10° C. or lower.

10. A method for breeding a bee, comprising the step of providing a bee feed according to claim 7 to the bee.

11. A method for breeding a bee, comprising the step of providing a sugar solution containing 1-kestose and an oligosaccharide other than 1-kestose and/or a monosaccharide as a feed to the bee.

12. The breeding method according to claim 11, wherein the sugar solution is a sugar solution containing sucrose as the oligosaccharide other than 1-kestose, wherein 3 parts by weight or more of 1-kestose is contained per 97 parts by weight of sucrose.

13. The sugar solution according to claim 2, wherein a Brix sugar level as measured by a sugar refractometer is 70 degrees or more.

14. The sugar solution according to claim 2, wherein the sugar solution has physical properties of precipitating no sugar crystal even under refrigeration at 4° C. for 21 days when the Brix sugar level as measured by a sugar refractometer is 75 degrees.

15. The sugar solution according to claim 2, wherein the sugar solution has physical properties of having a viscosity at 5° C. of 15000 mPa·s or less as measured at 200 rpm by a rotational viscometer when the Brix sugar level as measured by a sugar refractometer is 75 degrees.

16. A liquid sweetener prepared using a sugar solution according to claim 2.

17. A bee feed prepared using a sugar solution according to claim 2.

18. A method for producing a sweetened food or beverage, comprising the step of adding a liquid sweetener according to claim 16 to a food or a beverage.

19. The production method according to claim 18, wherein the food or the beverage is a food or a beverage to be preserved at 0° C. or higher and 10° C. or lower.

20. A method for breeding a bee, comprising the step of providing a bee feed according to claim 17 to the bee.
